(19) United States
(12) Patent Application Publication
(10) Pub. No.: US 2008/0312567 A1
(43) Pub. Date: Dec. 18, 2008

(54) Automatically retractable device for use in leg holder of massage machine

(76) Inventor: Ko-Po Chen, Ta-Li City (TW)

Correspondence Address: PRO-TECHTOR INTERNATIONAL SERVICES, 20775 NORADA CT., SARATOGA, CA, 95070, US

(21) Appl. No.: 11/818,380

(22) Filed: Jun. 14, 2007

(51) Int. Cl. A61H 15/00

(52) U.S. Cl. 601/98

(57) ABSTRACT

An automatically retractable device for use in a leg holder of a massage machine comprises a body axially disposed at the front end of the massage machine and including a driver and a connecting rod member both mounted thereon, and including outer and inner racks for an axial rotation and a resilient extraction, the outer rack pivotally coupled onto the driver of the body, and the inner rack including a sliding rail assembly and a controlling mechanism, the sliding rail assembly axially connected onto the connecting rod assembly, and the controlling mechanism including a retaining element and an engaging block axially fixed on the inner rack, and between the engaging block and the outer rack is secured a positioning portion and a fixing member for controlling the movement and position of the inner rack, thereby adjusting the expansion length of the inner rack based on user's leg length.

### BACKGROUND OF THE INVENTION

1. Field of the Invention

The present invention relates to an angular adjusting mechanism for use in a massage device of a massage machine that while a driver operating, an outer rack may be urged to swing upward and downward, and a connecting rod assembly simultaneously urges a sliding rail assembly and an inner rack to automatically extend or extract without a manual operation.

2. Description of the Prior Arts

Referring to FIGS. 1-3, TW Pat. No. 90216448 discloses “Massaging Leg Pad of Massaging Chair” including a body 1 having a retractable holder 2 axially disposed at the front side thereof and may swing upward and downward, wherein the retractable holder 2 is comprised of front and rear holding parts 21 and 22, the rear holding part 22 contains sliding slots 221 affixed at two sides thereof for slidably placing slidable members 211 at two sides of the front holding part 21, and includes a pivotal piece 23 having an arcuate hole 231 axially attached thereon, by using a positioning button 24 which is screwed on the rear holding part 22 to pass through the arcuate hole 231, the rear holding part 22 is locked, and the pivotal piece 23 includes an axial shaft 25 pivotally connected at another end thereof, and another end of the axial shaft 25 pivotally connects with the front holding part 21.

As shown in FIGS. 2-4, during adjusting the length of the front holding part 21, the positioning button 24 may be loosened, and the front holding part 21 may be pulled by hand and slides along the sliding slot 221 of the rear holding part 22 by using the slidable member 211. Besides, by using the axial shaft 25 to actuate the pivotal piece 23 for swing, the pivotal piece 23 displaces along the positioning button 24 by way of the arcuate hole 231, and after the front holding part 21 is pulled outward to the required length, the positioning button 24 is fastened tightly by hand for the position of the pivotal piece 23 and the front holding part 21, thereby adjusting the length of the front holding part 21.

Referring to FIGS. 3 and 4, during adjusting the length of the front holding part 21, the user has to unfasten the positioning button 24 by hand for releasing the position of the pivotal piece 23 and the front holding part 21, hence the front holding part 21 may be pulled outward to the required length, thereafter, the positioning button 24 is locked tightly, thereby positioning the front holding part 21 and the pivotal piece 23 so as to place the user's legs on the front holding part 21. Instead, as retracting the front holding part 21, the positioning button 24 is loosened, such that the front holding part 21 may be pushed back to the rear holding part 22. Further, the positioning button 24 is fastened tightly, and the front holding part 21 is storably positioned in the rear holding part 22, causing a manual adjusting operation.

The present invention has arisen to mitigate and/or obviate the afore-described disadvantages.

### SUMMARY OF THE INVENTION

The primary object of the present invention is to provide an angular adjusting mechanism for use in a massage device of a massage machine that while a driver operating, an outer rack may be urged to swing upward and downward, and a connecting rod assembly simultaneously urges a sliding rail assembly and an inner rack to automatically extend or extract without a manual operation.

Further object of the present invention is to provide an angular adjusting mechanism for use in a massage device of a massage machine that may control the movement and position of the inner rack, thereby adjusting the expansion length of the inner rack based on user's leg length.

Another object of the present invention is to provide an angular adjusting mechanism for use in a massage device of a massage machine that may be easily assembled and manufactured.

In accordance with one aspect of the present invention, there is provided an angular adjusting mechanism for use in a massage device of a massage machine comprising an automatically retractable device for use in a leg holder of a massage machine in accordance with the present invention comprises a frame of a body including a cylinder for a driver and a connecting rod assembly provided therein, the frame including outer and inner racks for an axial rotation and a resilient extraction, wherein the outer rack is pivotally disposed at the front side of the frame, and the leg holder includes a position rod of a cylinder pivotally connected to the bottom thereof, and contains sliding slots attached at two sides thereof, individually, and includes an inner rack slidably secured therein and having a spring mounted at the rear end thereof for coupling with the outer rack, and further having rollers affixed at two sides thereof for slidably fixing in the sliding slots, such that the inner rack may resiliently and retractably slide. Besides, the inner rack includes a sliding rail assembly and a controlling mechanism, a post member of the sliding rail assembly is defined in the inner rack and axially coupled with the connecting rod assembly by using the bottom of a holder. A controlling mechanism includes the inner rack on which an engaging block is axially mounted and includes a guiding portion and a hooking segment both attached at one end thereof and includes a fixing member pivotally secured at another end thereof for a linear displacement, and the holder involves a retaining element provided at the side thereof in response to the engaging block, for couplingly hooking the hooking segment of the engaging block, and the engaging block makes use of the axial shaft to be a fulcrum for its swing, the fixing member displaces inward, on the side of the fixing member corresponding to the outer rack are formed a plurality of positioning apertures for position.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram of a body and a massaging leg pad of TW Patent No. 90216448;

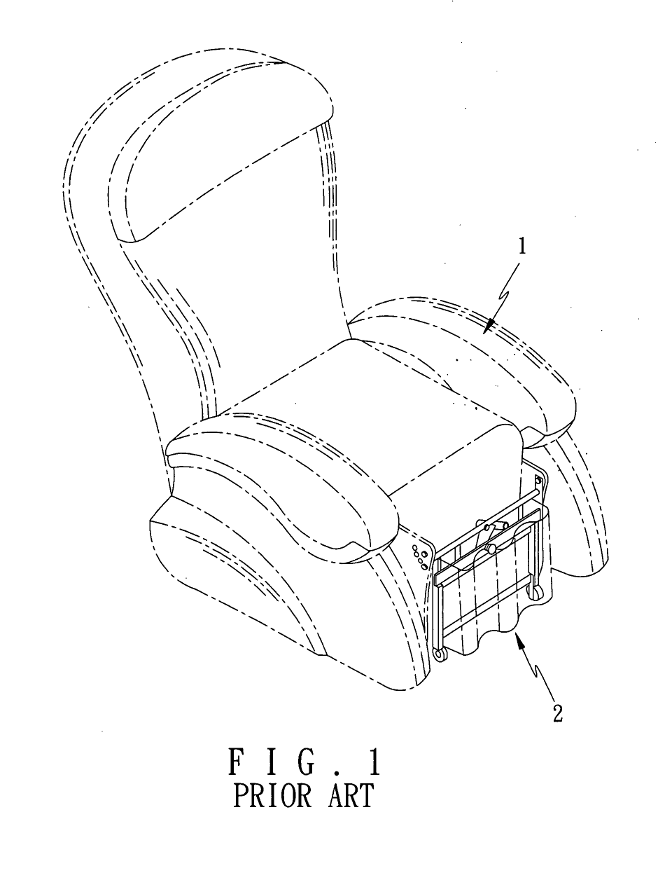

FIG. 2 is a plane diagram of the massaging leg pad of TW Patent No. 90216448;

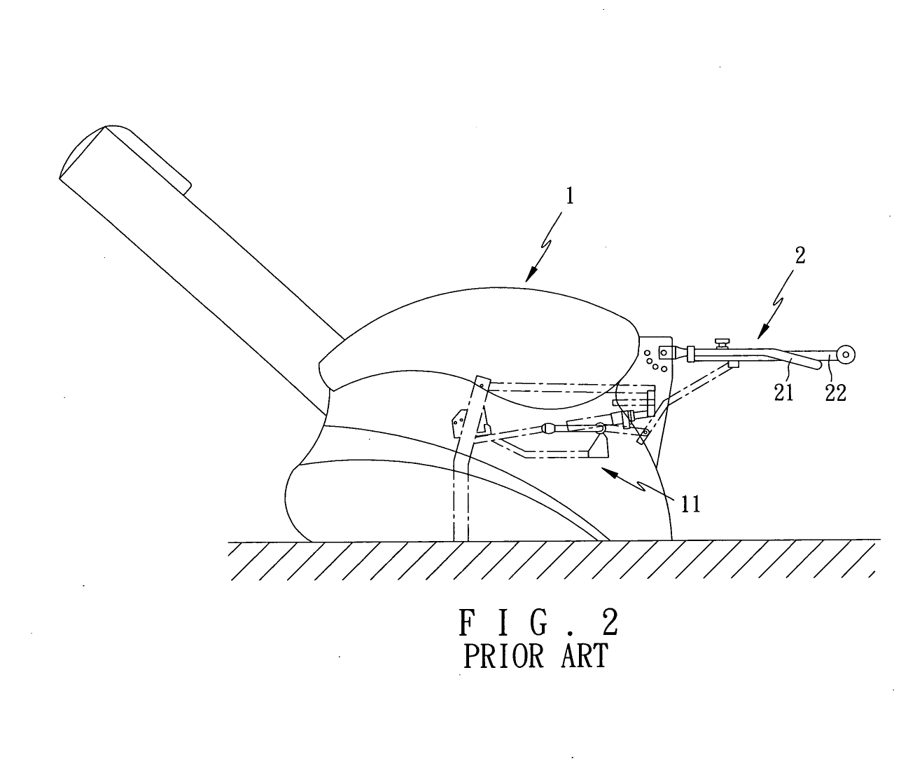

FIG. 3 is a plane diagram illustrating the operational state of the massaging leg pad of TW Patent No. 90216448 being placed laterally;

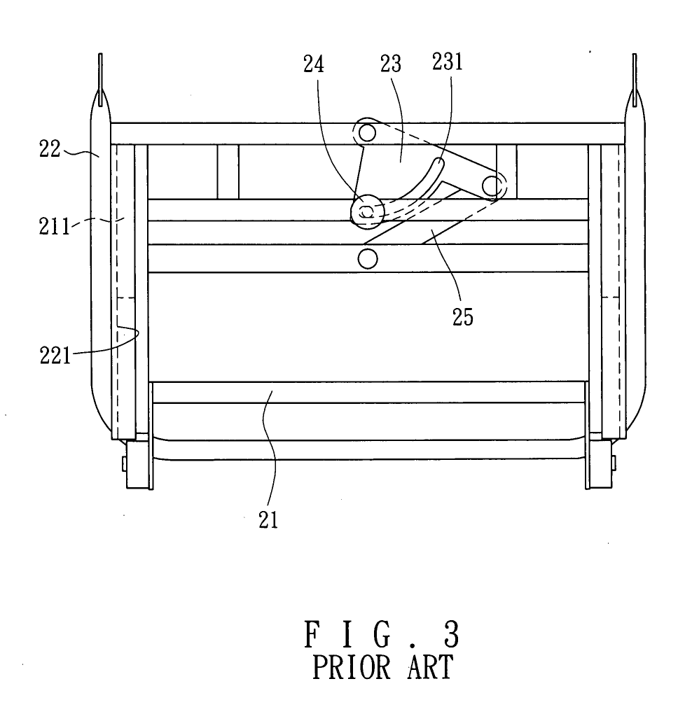

FIG. 4 is a plane diagram illustrating the operational state of the massaging leg pad of TW Patent No. 90216448 being extended out of a front holding part;

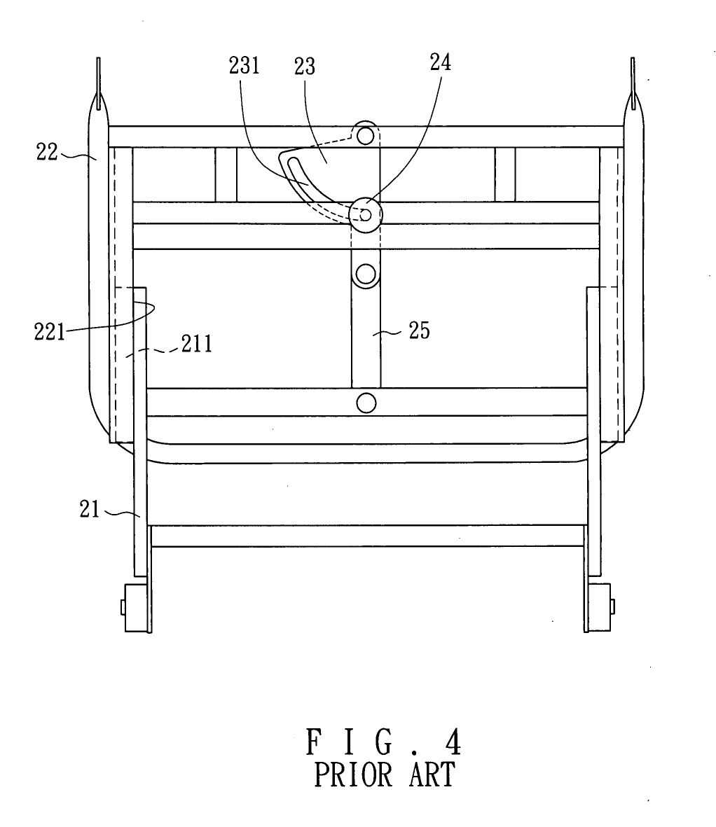

FIG. 5 is a plane diagram illustrating an automatically retractable device of a leg holder being disposed to a body of a massage machine of the present invention;

FIG. 6 is a perspective diagram of the automatically retractable device of the leg holder of the present invention;

FIG. 7 is a partial plane diagram of the automatically retractable device of the leg holder of the present invention;

FIG. 8 is a side diagram illustrating the automatically retractable device of the leg holder of the present invention controlling the swing of an outer rack and the outward extending of an inner rack;

FIG. 9 is a top plane diagram illustrating the automatically retractable device of the leg holder of the present invention controlling the swing of the outer rack and the outward extending of the inner rack;

FIG. 10 is a top plane diagram illustrating the automatically retractable device of the leg holder of the present invention releasing the connection of the inner rack and a holder;

FIG. 11 is a top plane diagram illustrating the automatically retractable device of the leg holder of the present invention automatically adjusting the inner rack's length;

FIG. 12 is an operational side diagram illustrating the automatically retractable device of the leg holder of the present invention controlling the swing of the outer rack and the automatic retraction of the inner rack;

FIG. 13 is a top plane diagram illustrating the automatically retractable device of the leg holder of the present invention controlling the swing of the outer rack and the automatic retraction of the inner rack;

FIG. 14 is another operational side diagram illustrating the automatically retractable device of the leg holder of the present invention controlling the swing of the outer rack and the automatic retraction of the inner rack;

FIG. 15 is another top plane diagram illustrating the automatically retractable device of the leg holder of the present invention controlling the swing of the outer rack and the automatic retraction of the inner rack.

### DETAILED DESCRIPTION OF THE PREFERRED EMBODIMENT

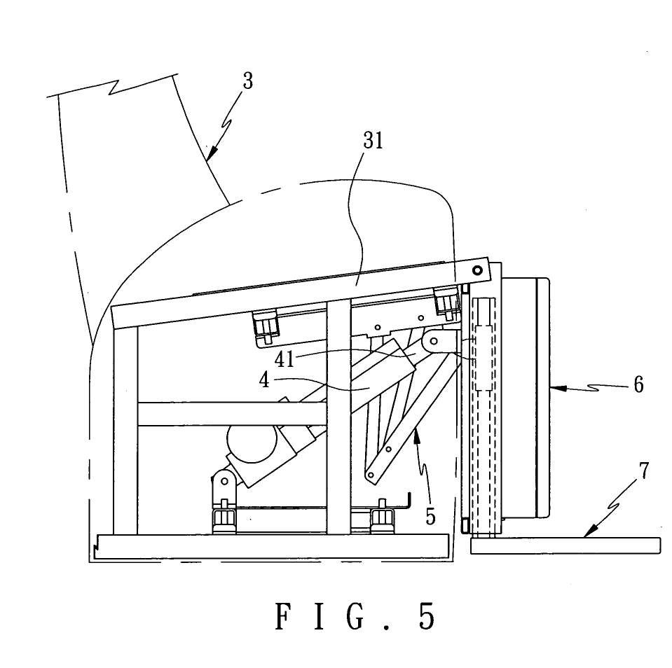

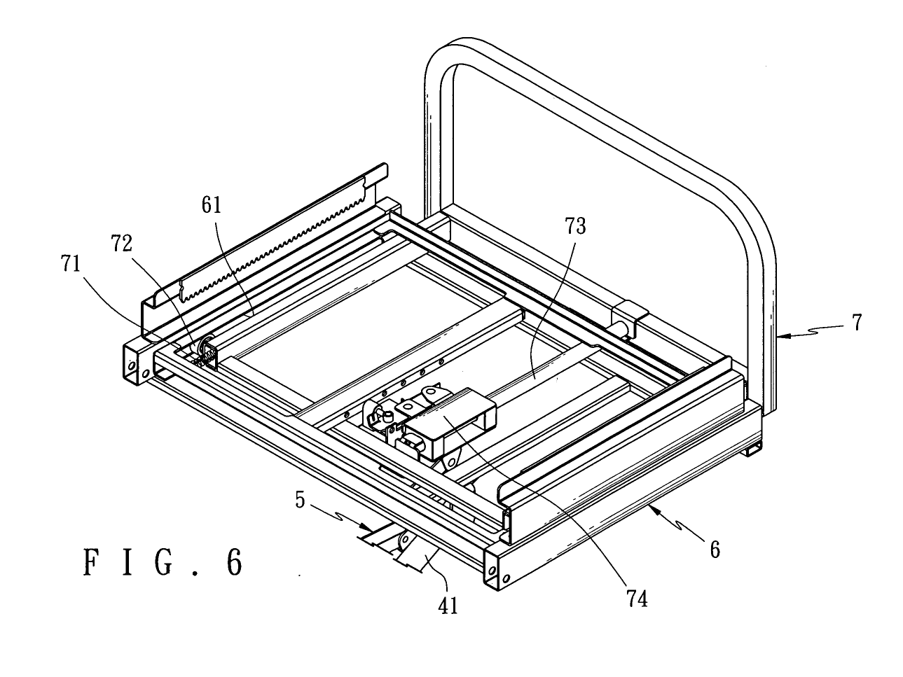

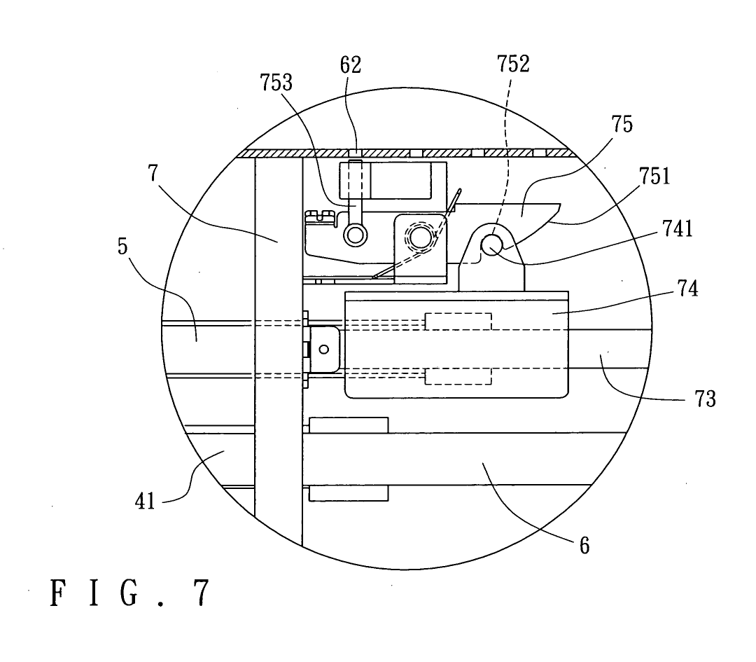

Referring to FIGS. 5-7, an automatically retractable device for use in a leg holder of a massage machine in accordance with the present invention comprises a frame 31 of a body 3 including a cylinder 4 for a driver and a connecting rod assembly 5 provided therein, the frame 31 including outer and inner racks 6, 7 for an axial rotation and a resilient extraction, wherein the outer rack 6 is pivotally disposed at the front side of the frame 31, and the leg holder includes a position rod 41 of a cylinder 4 pivotally connected to the bottom thereof, and contains sliding slots 61 attached at two sides thereof, individually, and includes an inner rack 7 slidably secured therein and having a spring 71 mounted at the rear end thereof for coupling with the outer rack 6, and further having rollers 72 affixed at two sides thereof for slidably fixing in the sliding slots 61, such that the inner rack 7 may resiliently and retractably slide. Besides, the inner rack 7 includes a sliding rail assembly and a controlling mechanism, a post member 73 of the sliding rail assembly is defined in the inner rack 7 and axially coupled with the connecting rod assembly 5 by using the bottom of a holder 74. A controlling mechanism includes the inner rack 7 on which an engaging block 75 is axially mounted and includes a guiding portion 751 and a hooking segment 752 both attached at one end thereof and includes a fixing member 753 pivotally secured at another end thereof for a linear displacement, and the holder 74 involves a retaining element 741 provided at the side thereof in response to the engaging block 75, for couplingly hooking the hooking segment 752 of the engaging block 75, and the engaging block 75 makes use of the axial shaft to be a fulcrum for its swing, the fixing member 753 displaces inward, on the side of the fixing member 753 corresponding to the outer rack 6 are formed a plurality of positioning apertures 62 for position.

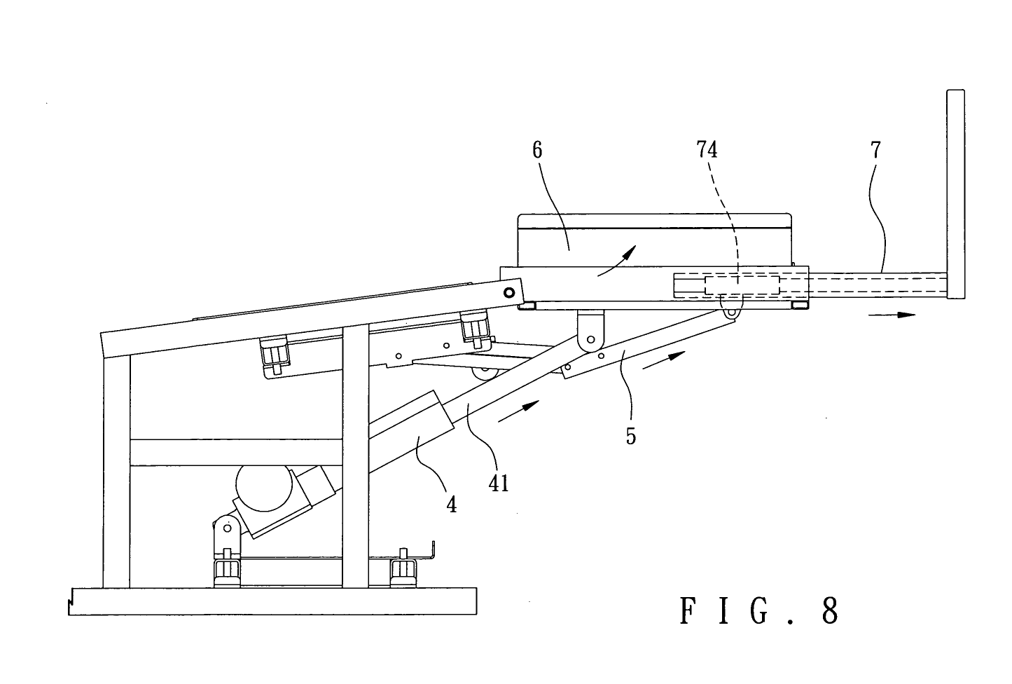

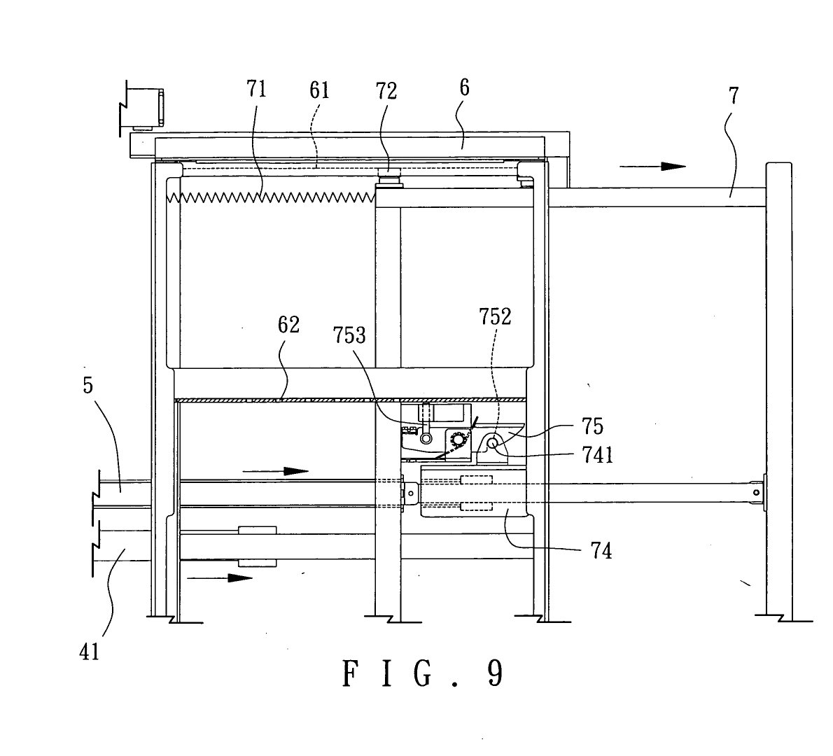

As shown in FIGS. 8 and 9, in the operation of the leg holder, user may drive the cylinder 4 to make the position rod 41 to extend forward, and straightly urges the outer rack 6 to swing upwardly at any desired angle. For example, as the outer rack 6 swing upwardly, it actuates the inner rack 7 to swing upward as well, and the connecting rod assembly 5 extends forward, because the holder 74 engages with the hooking segment 752 of the engaging block 75 by using the retaining element 741 and the engaging block 75 is axially fixed on the inner rack 7. Besides, the fixing member 753 removes the positioning aperture 62 of the outer rack 6 so that the inner rack 7 moves with the holder 74, and the holder 74 actuates the inner rack 7 to displace forward to pull the spring 71, hence the inner rack 7 may swing upwardly with the outer rack 6 and extends toward a lateral place, simultaneously, the inner rack 7 automatically extends outward for placing user's legs.

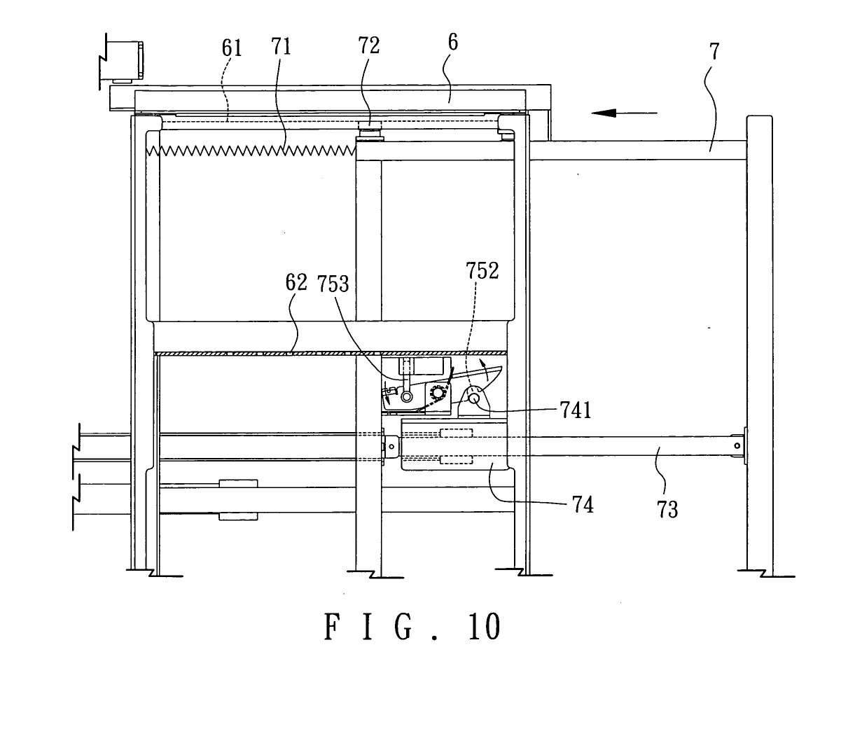

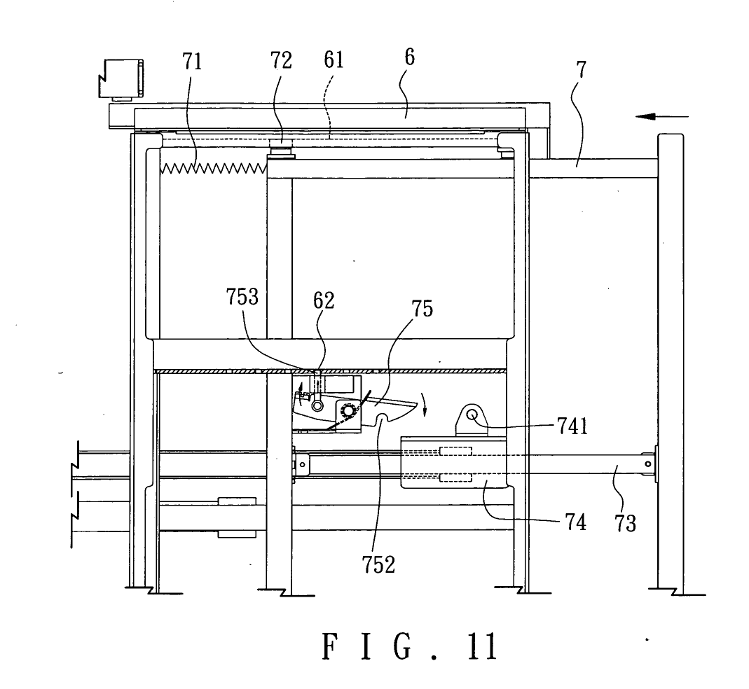

With reference to FIGS. 10 and 11, while adjusting the length of the inner rack 7, the hooking segment 752 of the engaging block 75 removes from the retaining element 741 of the holder 74 so that the engaging block 75 causes a resilient returning, therefore the fixing member 753 swings outward, and the inner rack 7 may independently displace and returns by means of the spring 71 of the outer rack 6, by using the roller 72 and the post member 73 to automatically displace inward along the sliding slot 61 and the holder 74, after adjusting the length of the inner rack 7, the fixing member 753 inserts into the positioning aperture 62 of the outer rack 6 to retain the inner rack 7, achieving the length adjustment of the inner rack 7.

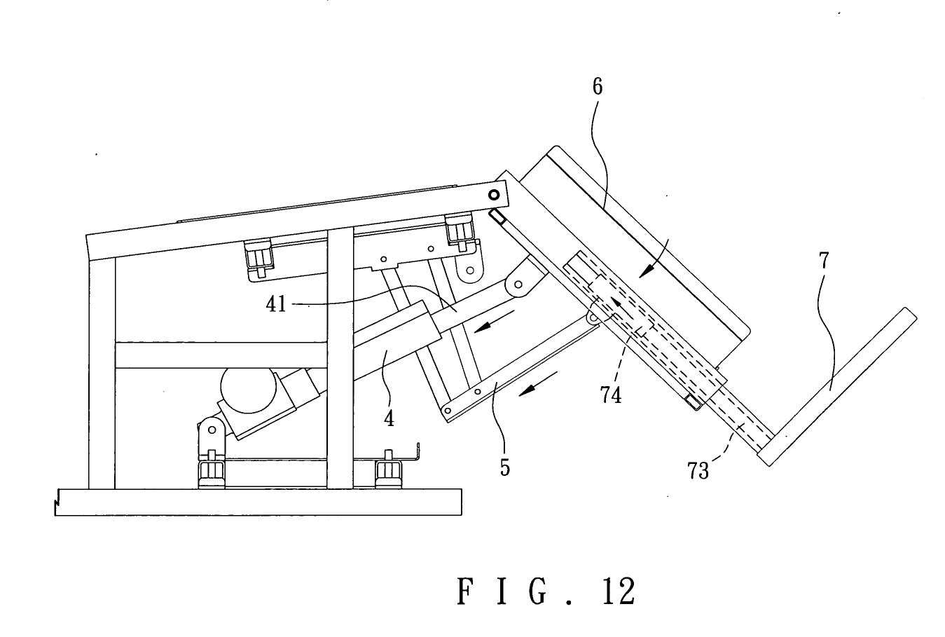

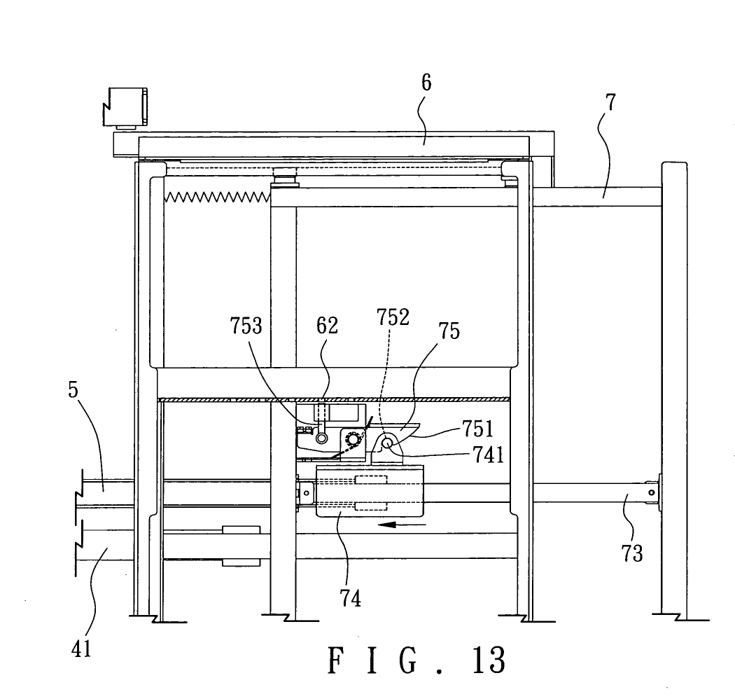

Referring to FIGS. 11-13, as retracting the inner and outer racks 7 and 6, the cylinder 4 is urged to inwardly retract the position rod 41 so as to actuate the outer rack 6 to swing downwardly, and the connecting rod assembly 5 rearward retracts, since the holder 74 does not connect with the engaging block 75 of the inner rack 7, the connecting rod assembly 5 actuates the holder 74 to displace inward, and as the retaining element 741 contacts with the engaging block 75, the retaining element 741 is guided by the guiding portion 751 of the engaging block 75 and hooks with the hooking segment 752 such that the holder 74 and the inner rack 7 may simultaneously move, and the engaging block 75 swings by using the axial shaft as its fulcrum, thereby the fixing member 753 disengages from the positioning aperture 62 of the outer rack 6 so that the holder 74 may actuate the inner rack 7 to move inwardly.

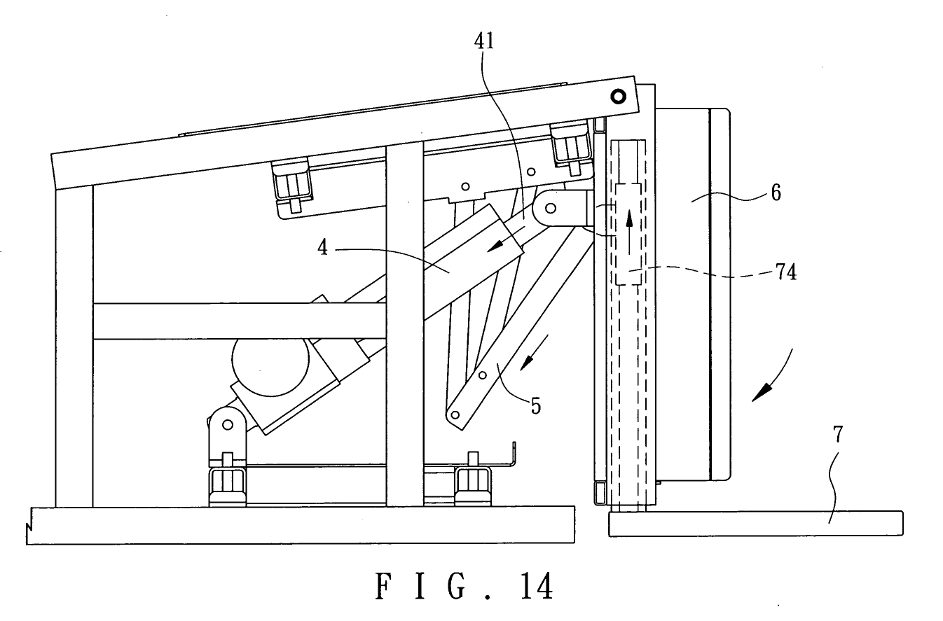

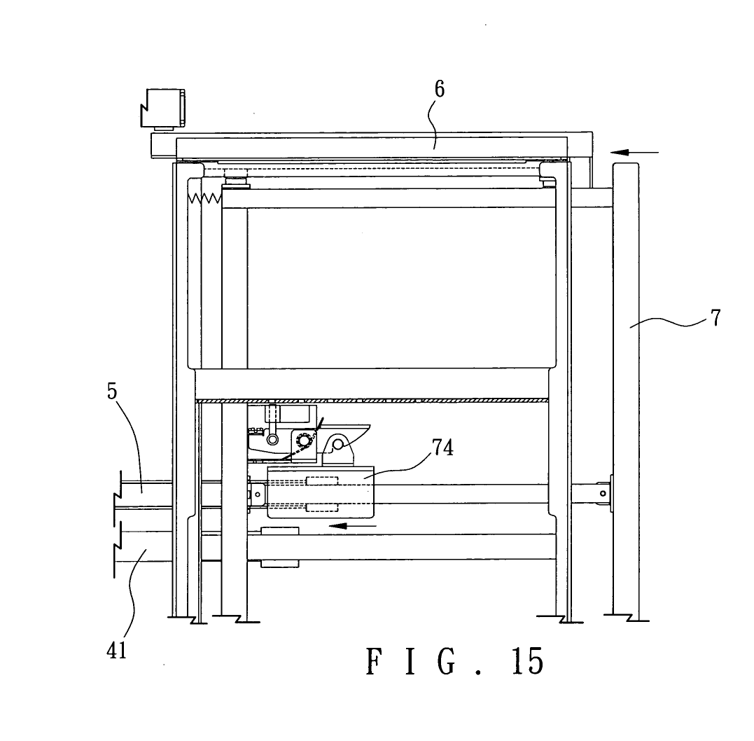

As shown in FIGS. 14 and 15, since the holder 74 and the inner rack 7 are connected with each other and simultaneously moves, as the position rod 41 of the cylinder 4 keeps on actuating the outer rack 6 to swing downwardly for retraction, the connecting rod assembly 5 also keeps on actuating the holder 74 to move inward, by which the inner rack 7 displaces inwardly for retraction back to the outer rack 6 and as the outer rack 6 swings downwardly to the vertical status, the inner rack 7 automatically retracts back to the outer rack 6, obtaining the automatic retraction into the inner and outer racks 7 and 6.

The invention is not limited to the above embodiment but various modifications thereof may be made. It will be understood by those skilled in the art that various changes in form and detail may made without departing from the scope and spirit of the present invention.

What is claimed is:

1. An automatically retractable device for use in a leg holder of a massage machine comprising:
a body axially disposed at the front end of the massage machine and including a driver and a connecting rod member both mounted thereon, and including outer and inner racks for an axial rotation and a resilient extraction, said outer rack pivotally coupled onto said driver of said body, and said inner rack including a sliding rail assembly and a controlling mechanism, said sliding rail assembly axially connected onto said connecting rod assembly, and said controlling mechanism including a retaining element and an engaging block axially fixed on said inner rack, and between said engaging block and said outer rack is secured a positioning portion and a fixing member for controlling the movement and position of said inner rack.

2. The automatically retractable device for use in a leg holder of a massage machine as claimed in claim 1, wherein said driver is a cylinder for axially coupling with said outer rack by a position rod.

3. The automatically retractable device for use in a leg holder of a massage machine as claimed in claim 1, wherein said outer rack contains sliding slots attached at two sides thereof, individually, and said inner rack includes rollers affixed at two sides thereof for slidably fixing in said sliding slots.

4. The automatically retractable device for use in a leg holder of a massage machine as claimed in claim 1, wherein between said inner and outer racks is defined with a spring.

5. The automatically retractable device for use in a leg holder of a massage machine as claimed in claim 1, wherein said sliding slot is attached on said inner rack and axially connected with said connecting rod assembly.

6. The automatically retractable device for use in a leg holder of a massage machine as claimed in claim 5, wherein said controlling mechanism including a retaining element provided on said holder, and said inner rack includes said engaging block for resiliently swing thereon and having a hooking portion affixed at one end thereof for hooking in said retaining element and having said fixing member pivotally attached at another end thereof, said outer rack is provided at the side of said fixing member with a plurality of fixing portions, each may be a positioning aperture.

7. The automatically retractable device for use in a leg holder of a massage machine as claimed in claim 6, wherein said engaging block of said inner rack is defined with a guiding portion at one end thereof.
